(19) United States
(12) Patent Application Publication
(10) Pub. No.: US 2015/0040140 A1
(43) Pub. Date: Feb. 5, 2015

(54) Consuming Ordered Streams of Messages in a Message Oriented Middleware

(71) Applicant: International Business Machines Corporation, Armonk, NY (US)

(72) Inventors: Peter A. Broadhurst, Eastleigh (GB); Alan J. Chatt, Salisbury (GB)

(21) Appl. No.: 14/448,075

(22) Filed: Jul. 31, 2014

(30) Foreign Application Priority Data
Aug. 1, 2013 (GB) 1313775.7

(51) Int. Cl. G06F 9/54

(52) U.S. Cl. CPC G06F 9/546
USPC 719/314

(57) ABSTRACT

A mechanism is provided for consuming ordered streams of messages in a message oriented middleware having a single queue. The mechanism provides a first consuming application thread to process a first message, locks the first message when available on the queue to the first application thread and locking all subsequent messages on the queue with the same stream identifier as the first message to the first application thread, and identifies any messages with different stream identifiers currently locked to the first application thread, and making available the further messages to other application threads; delivering the first message. The mechanism also provides a second consuming application thread to process a subsequent message, locks a next unlocked message when available on the queue to the second consuming application, and locks all subsequent messages on the queue with the same stream identifier as the next unlocked message to the second consuming application thread.

### BACKGROUND

This invention relates to the field of message oriented middleware. In particular, the invention relates to consuming ordered steams of messages in a message oriented middleware.

Message oriented middleware (MOM) technologies provide a first-in-first-out ordered queue of messages. When there is a single producer of messages to a queue, and a single consumer of messages from that queue, the order of messages is preserved between the producer and consumer.

A common scenario where message order is required is where each piece of data flowing in a message contains an action to be performed for a particular entity. For example, updates to an individual customer record. In this case, all of the messages flow through a single queue, and might be associated with thousands, or millions, of different entities.

Messages on a queue may occur in a physical or logical order. Physical order is the order in which messages arrive on a queue. Logical order is when all of the messages and segments within a group are in their logical sequence, adjacent to each other, in the position determined by the physical position of the first item belonging to the group. Groups may arrive at a destination at similar times from different applications, therefore losing any distinct physical order.

A group identifier may be provided in messages to indicate that they belong to the same group. Logical messages within a group may be identified by a group identifier and a message sequence number in fields in a header of the message.

All of the actions for a particular entity must be performed in order. However, the sender of a message does not know whether the action it is sending is the first action for that entity, or if it is the last action for that entity. This scenario is referred to as the “stream scenario”, with a set of messages containing actions associated with a single entity as a “stream”, and the name of the entity that uniquely identifies the stream as the “stream identifier”.

Existing MOM technologies, such as WebSphere® MQ (WebSphere is a trade mark of International Business Machines Corporation), provide the ability to prevent multiple consuming threads from attaching to the same queue to consume messages. This exclusive access check, allows a consuming application to have high availability in the stream scenario, as it can have multiple inactive instances attempting to attach to the queue, with a single instance successfully attaching.

The limitation of the stream scenario is that there is no ability to scale the application logic that consumes the messages. The processing of all streams of messages from a single queue is bottlenecked by the processing speed of a single consuming thread within the application.

Other prior art methods require sequence start and end information to be supplied by the application.

Still further methods use multiple queues internally to split out the workload.

This problem may be addressed in the layer above the messaging system, for example, by use of a single consumer to scan each arriving message and assign it to a thread of execution. This adds complexity for the messaging system user and is more likely to introduce a bottleneck in the system.

Therefore, there is a need in the art to address the aforementioned problems.

### SUMMARY

According to an illustrative embodiment, there is provided a method for consuming ordered streams of messages in a message oriented middleware having a single queue, comprising: providing a first consuming application thread to process a first message; locking the first message when available on the queue to the first application thread and locking all subsequent messages on the queue with the same stream identifier as the first message to the first application thread; identifying any messages with different stream identifiers currently locked to the first application thread, and making available the further messages to other application threads; delivering the first message.

The method may comprise: providing a second consuming application thread to process a subsequent message; locking a next unlocked message when available on the queue to the second consuming application and locking all subsequent messages on the queue with the same stream identifier as the next unlocked message to the second consuming application thread wherein parallel processing of messages is carried out by the first and second consuming application threads.

The method may include: checking if a next message available on the queue for the first application thread is locked with the same stream identifier as the first message; and, if so, delivering the next message to the first application thread. The method may further include waiting a period of time for messages with the same stream identifier as the first message before the first application thread receives a message with a different stream identifier.

The method may include providing a stream identifier in a message being put to a queue.

A consuming thread application may remember a last stream that the application thread processed a message from. The method may include releasing an application thread's ownership of a stream when the application thread processes another message. A consuming application thread may finish processing each message before it requests the next message.

According to another illustrative embodiment, there is provided a system for consuming ordered streams of messages in a message oriented middleware having a single queue, comprising: an application thread availability component providing a first consuming application thread to process a first message; a message availability component tor a first available message on the queue; a locking component for locking the first message when available on the queue to the first application thread and locking all subsequent messages on the queue with the same stream identifier as the first message to the first application thread; a lock check component for identifying any messages with different stream identifiers currently locked to the first application thread; a lock release component for making available the further messages to other application threads; and a message delivery component for delivering the first message.

The system may further include: the application thread availability component providing a second consuming application thread to process a subsequent message; and the locking component locking a next unlocked message when available on the queue to the second consuming application and locking all subsequent messages on the queue with the same stream identifier as the next unlocked message to the second consuming application thread wherein parallel processing of messages is carried out by the first and second consuming application threads.

The system may include the message availability component checking if a next message available on the queue for the first application thread is locked with the same stream identifier as the first message. The system may further include the message availability component waiting a period of time for messages with the same stream identifier as the first message before the first application thread receives a message with a different stream identifier.

The system may include a stream identifier provided in a message being put to a queue

A consuming application thread may remember a last stream that the application thread, processed a message from. The lock release component may be for releasing an application thread's ownership of a stream when the application thread processes another message. A consuming application thread may finish processing each message before it requests the next message.

According to another illustrative embodiment, there is provided a computer program product for consuming ordered streams of messages in a message oriented middleware having a single queue, the computer program product comprising: a computer readable storage medium readable by a processing circuit and storing instructions for execution by the processing circuit for performing a method according to the first aspect of the present invention.

The described aspects of the invention provide the advantage of enabling consumer applications to process streams of messages from a single queue in parallel. This has the advantage of allowing applications consuming ordered streams of messages on a single message queue to scale.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Preferred embodiments of the present invention will now be described, by way of example only, with reference to the following drawings in which:

FIG. 1 is a schematic diagram showing a flow of an embodiment of a method of ensuring message order applied to a stream scenario as known in the prior art;

FIG. 2 is a schematic diagram showing a flow of ordered stream access logic in accordance with an illustrative embodiment;

FIG. 3 is block diagram of a system of ordered stream access logic in accordance with an illustrative embodiment;

FIG. 4 is a block diagram of a computer system in which aspects of the illustrative embodiments may be implemented; and

FIGS. 5A and 5B are flow diagrams an aspect of a method of ordered stream access logic in accordance with an illustrative embodiment.

### DETAILED DESCRIPTION

It will be appreciated that for simplicity and clarity of illustration, elements shown in the figures have not necessarily been drawn to scale. For example, the dimensions of some of the elements may be exaggerated relative to other elements for clarify. Further, where considered appropriate, reference numbers may be repeated among the figures to indicate corresponding or analogous features.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

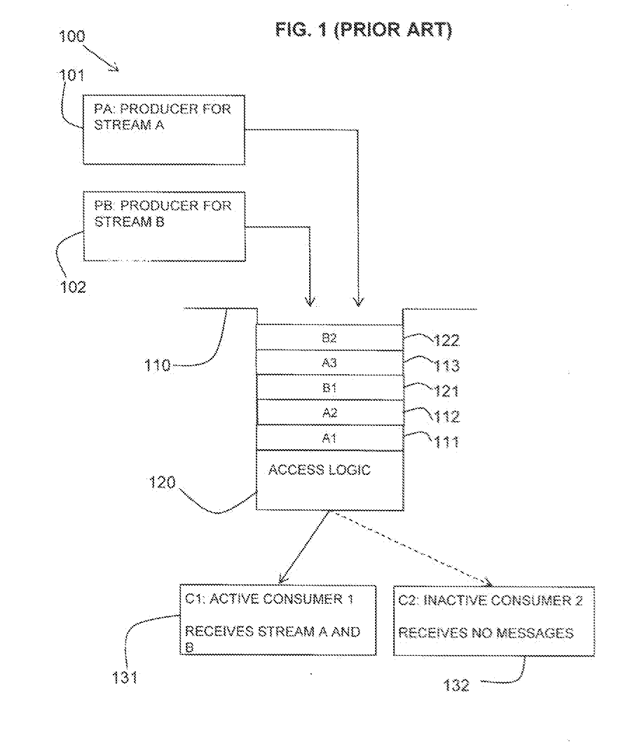

FIG. 1 shows a system 100 illustrating the prior art solution of ensuring message order applied to the stream scenario described in the background section.

A first producer 101 may be a single application thread sending messages for stream A (PA) and a second producer 102 may be a single application thread (possibly the same thread as PA) sending messages for stream B (PB).

A single queue 110 is provided in the form of a first-in-first-out (FIFO) ordered queue. The queue 110 shows queued messages 111-113, 121-122 in the form of messages relating to stream A 111-113 and stream B 121-122. Access logic 120 may be provided for the queue 110 in the form of an exclusive access checking logic performed by the MOM.

A first consumer (C1) 131 and a second consumer (C2) 132 may be provided. The access logic 120 may prevent the second consumer (C2) 132 from attaching to the queue 110 while the first consumer (C1) 131 is attached. The first consumer (C1) 131 receives all messages, for stream A and stream B, in the order in which they were sent by the producer 101 for stream A (PA) and the producer 102 for stream B (PB).

A mechanism is now described that provides an alternative access logic that allows multiple consumers to be active concurrently. The benefit of the described access logic is that it is a stream-based exclusive access checking logic that allows multiple consumers to be active against a queue, while ensuring that all messages on a given stream are processed in the order they were sent.

The described mechanism allows multiple consumers be active against a queue such that messages on a stream are processed in the correct order. Messages from a first stream A may be processed by a first consumer, but not a second consumer; and messages from a second stream B may be delivered to the second consumer, while the first consumer is processing messages from the first stream A.

The described mechanism enables ordered processing of messages in a single message queue connected to multiple producers and multiple consumers where the multiple consumers can process the messages in parallel.

More specifically, the mechanism may perform concurrent, ordered processing of multiple streams of messages from a single queue by locking all messages from a first stream to a processing thread and upon detecting that a message from another stream is also locked to the processing thread, releasing ownership on the first stream so that other processing threads may process the first stream.

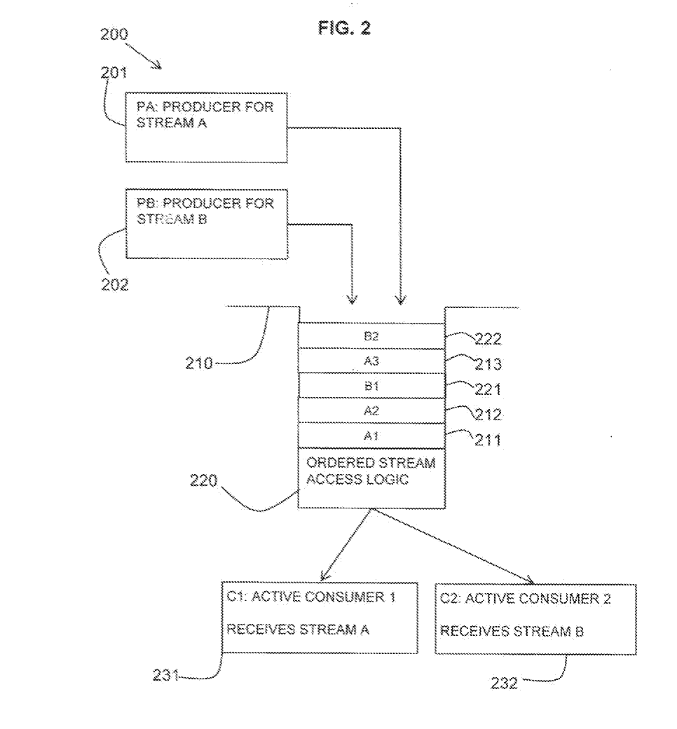

Referring to FIG. 2, a system 200 corresponding to that shown in FIG. 1 is provided with the described, ordered stream access logic 220.

As in FIG. 1, a first producer 201 may be a single application thread sending messages for stream A (PA) and a second producer 202 may be a single application thread (possibly the same thread, as PA) sending messages for stream B (PB).

A single queue 210 is provided in the form of a first-in-first-out (FIFO) ordered queue. The queue 210 shows queued messages 211-213, 221-222 in the form of messages relating to stream A 211-213 and stream B 221-222. The messages may include stream identifiers identifying in the message which stream they belong to. The stream identifiers may take the form of a “GroupId” identifier in the header of the message.

In this system, ordered stream access logic 220 may be provided for the queue 210 performed by the MOM.

A first consumer (C1) 231 and a second consumer (C2) 232 may be provided. The ordered stream access logic 220 allows both the first consumer (C1) 231 and second consumer (C2) 232 to be active concurrently.

In this case the ordered stream access logic 220 allows both the first consumer (C1) 231 and second consumer (C2) 232 to attach to the queue 210. It ensures that while messages from stream A are being processed by the first consumer (C1) 231, messages from stream A are not delivered to the second consumer (C2) 232. This preserves in-ordered processing for the stream.

Messages from stream B may be delivered to the second consumer (C2) 232 while the first consumer (C1) 231 is processing messages from stream A. This allows parallel execution of the application logic, using a single queue.

The ordered stream access logic 220 controls the locking of messages for a given consumer based on the stream identifier in the messages. Messages from a stream may be locked to a consumer whilst allowing other consumers to receive messages not on the locked stream.

Implementing the described ordered stream access logic within an existing MOM technology requires minimal work. The triggering points for the logic are where threads indicate they are ready for a new message, and when a message becomes available. Both of these are likely to be primary trigger points for logic within an existing MOM technology.

A feature of the described logic is that it is designed to require minimal state to be stored. This is because long term storage of state data is impractical when there are thousands/millions of different streams of data, and information about the start and end of stream is invisible to the MOM. For example, a stream identifier such as a customer identifier might last for years, with months between messages on the stream.

Another factor considered in the described logic is that many applications process ordered streams of messages outside of transactions, so it is often invisible to the MOM technology when the application has finished processing one message in a stream, and hence it is safe to deliver the next message in that stream to an application thread.

The approach taken by the described logic is to remember only the last stream that an application thread processed messages from, and to release an application thread's ownership of that stream only when that application thread processes another message. This allows application logic to process safely in parallel on different streams, while minimising the state held in memory by the MOM, and preventing any persistence of state within the MOM.

A consuming application may finish processing each message before it requests the next message from the MOM.

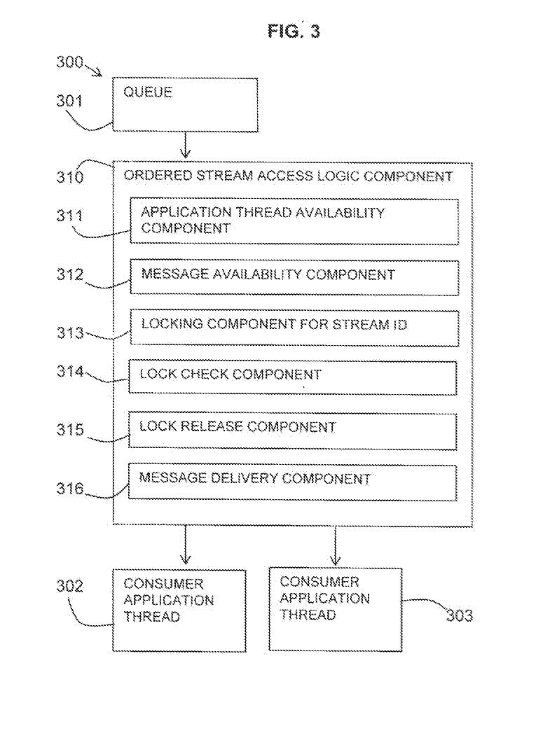

Referring to FIG. 3, a block diagram shows an example embodiment of the described system 300 with further detail of the ordered stream access logic.

A single queue 301 may be provided as part of a message oriented middleware system. An ordered stream access logic component 310 (hereafter referred to as the logic component) may be provided to process message consumption from the queue 301 by consumer application threads 302, 303.

There may be any number of consumer application threads 302, 303 and the described logic component 310 enables the consumer application threads 302, 303 to consume messages from the queue 301 in parallel with each consumer application thread 302, 303, consuming messages relating to a stream identified by a stream identifier in the messages.

The logic component 310 may include an application thread availability component 311 and a message availability component 312 which are triggering points for the logic component 310. The application thread availability component 311 may trigger when a consumer application thread 302, 303 indicates that it is ready for a new message. The message availability component 312 may trigger when a message becomes available on the queue 301, including when a message is unlocked by a lock release component 315.

The logic component 310 may include a locking component 313 for stream identifier which may lock messages on the queue 301 with a stream identifier. A first available message may be locked and all other messages arriving on the queue 301 with the same stream identifier may also be locked. This ensures that only a consumer application thread 302, which consumes a first message with a given stream identifier, will be able to consume the other messages with the same stream identifier until the stream is unlocked due to the consumer application thread 302 locking to a different stream identifier.

A lock check component 314 may be provided to check that no messages on a different stream (with a different stream identifier) are currently locked to the consumer application thread 302 that is consuming the new stream.

A lock release component 315 may be provided for making messages on other stream identifiers available to all application threads until a stream identifier is locked for a given consumer application thread 302, 303.

A message delivery component 316 may be provided for delivering messages to a given consumer application thread 302, 303 based on locks of the messages for the consumer application thread 302, 303.

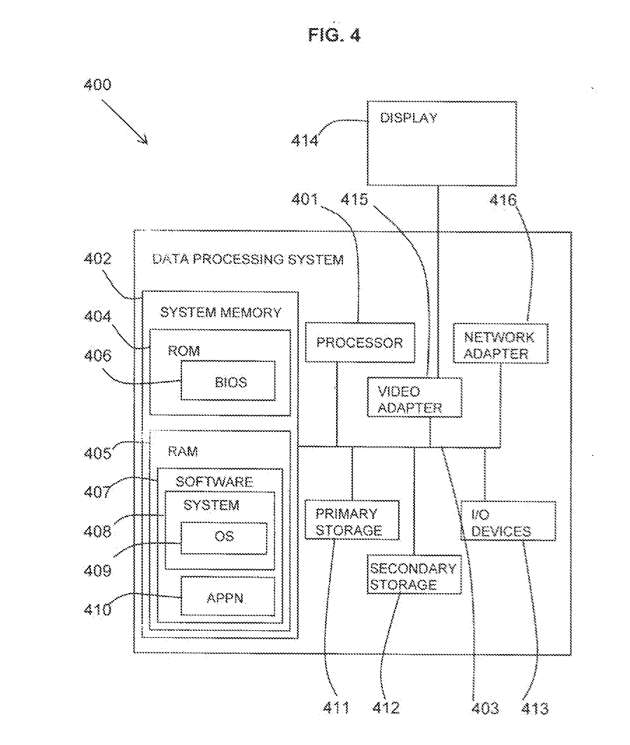

Referring to FIG. 4, an exemplary system for implementing aspects of the invention includes a data processing system 400 suitable for storing and/or executing program code including at least one processor 401 coupled directly or indirectly to memory elements through a bus system 403. The memory elements may include local memory employed during actual execution of the program code, bulk storage, and cache memories which provide temporary storage of at least some program code in order to reduce the number of times code must be retrieved from bulk storage during execution.

The memory elements may include system memory 402 in the form of read only memory (ROM) 404 and random access memory (RAM) 405. A basic input/output system (BIOS) 406 may be stored in ROM 404. Software 407, including system software 408 may be stored in RAM 405 including operating system software 409. Software applications 410 may also be stored in RAM 405.

The system 400 may also include a primary storage means 411 such as a magnetic hard disk drive and secondary storage means 412 such as a magnetic disc drive and an optical disc drive. The drives and their associated computer-readable media provide non-volatile storage of computer-executable instructions, data structures, program modules and other data for the system 400. Software applications may be stored on the primary and secondary storage means 411,412 as well as the system memory 402.

The computing system 400 may operate in a networked, environment using logical connections to one or more remote computers via a network adapter 416.

Input/output devices 413 may be coupled to the system either directly or through intervening I/O controllers, A user may enter commands and information into the system 400 through input devices such as a keyboard, pointing device, or other input devices (for example, microphone, joy stick, game pad, satellite dish, scanner, or the like). Output devices may include speakers, printers, etc. A display device 414 is also connected to system bus 403 via an interface, such as video adapter 415.

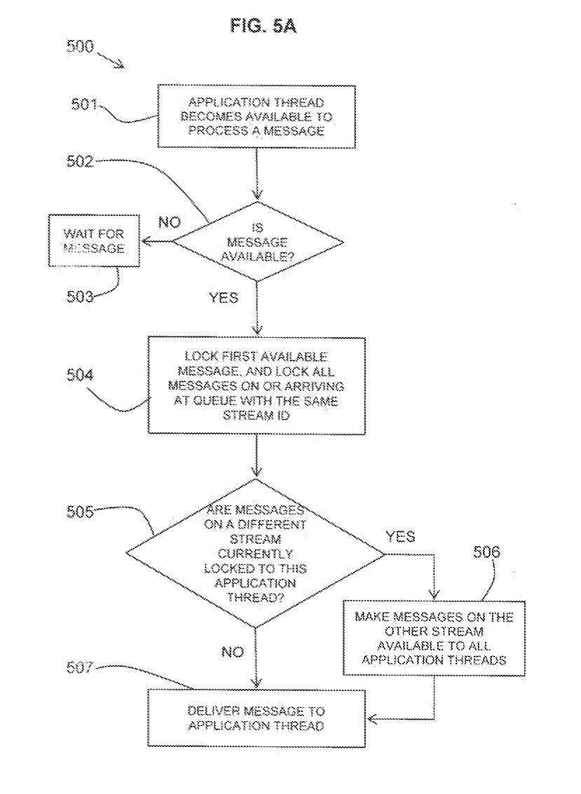

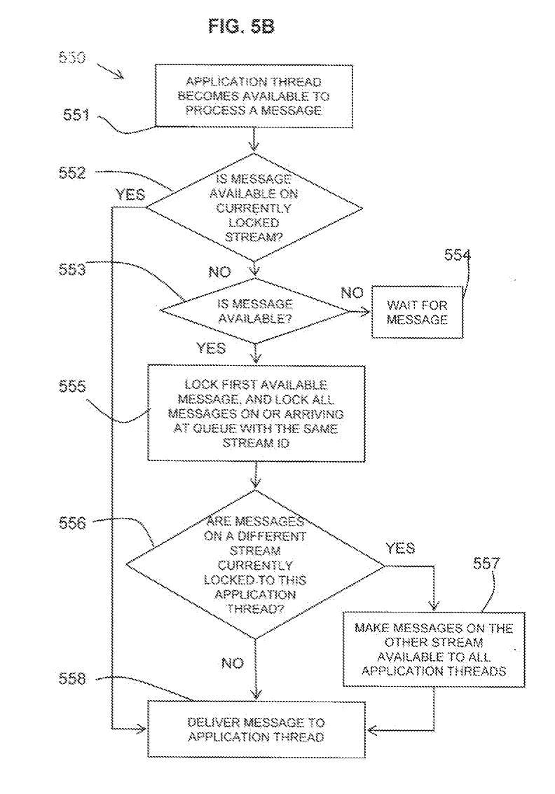

Referring to FIG. 5A, a flow diagram 500 shows a first example embodiment of the described method as carried, out by the ordered stream access logic.

An application thread may become available 501 to process a message. It may be determined 502 if a message is available on the queue. If no message is currently available on the queue, the process may wait for a message 503.

When a message becomes available, it may be locked 504 to the available application thread and all messages on or arriving at the queue with the same stream identifier as the first available message may also be locked.

It may be determined 505 if there are messages on a different stream currently locked to this application thread. If so, the messages on the other stream may be made available 506 to ail application threads. The message may then be delivered 507 to the application thread.

The reasoning of always switching streams and for the queue to be as FIFO as possible, is that there could, be many messages on the queue in-between the last locked message and the next locked, messages, and. these messages would have to wait until a thread becomes available that was not locked to any existing stream before being processed.

For example, if there are five threads consuming from a queue that had five very active streams, and occasional messages for other streams, then most of the time all five threads could be locked to streams and. the messages on other streams may wait a very long time to be processed.

However, if the pattern of usage of the queue means that there is no concern about delaying the processing of unlocked messages in order to process locked messages that exist further down the queue, the second embodiment described below may be used.

Referring to FIG. 5B, a flow diagram 550 shows a second example embodiment of the described method as carried out by the ordered stream access logic.

An application thread may become available 551 to process a message. In this embodiment, an additional step may be provided to determine 552 if a message is available on a currently locked stream of the application. If so, the method may skip directly to step 558 of delivering the message to the application thread.

If there is no message available on a currently locked stream, then the method may proceed as in Figure 5A and it may be determined 553 if any message is available on the queue. If no message is currently available on the queue, the process may wait for a message 554.

When a message becomes available, it may be locked 555 to the available application thread and all messages on or arriving at the queue with the same stream identifier as the first available message may also be locked.

It may be determined 556 if there are messages on a different stream currently locked to this application thread. If so, the messages on the other stream may be made available 557 to ail application threads. The message may then be delivered 558 to the application thread.

Additionally, the processing may wait for a period at step 552 for more messages on the currently locked stream before delivering messages on a different stream to an application thread.

This may benefit performance in cases where application logic caches state associated with the stream processed last, and hence operates more efficiently if groups of messages that arrive for a particular stream are all dispatched to the same thread.

The described ordered stream access logic delivers the following specific benefits to the MOM implementation, and the applications that attach.

The MOM does not need to persist any state about the streams, or the consumers. It only needs to retain in-memory state on the streams currently on the queue, and the consumers currently attached to the queue.

The producing application does not need to demark the beginning or end of a stream. It only needs to supply the stream identifier with each message.

The consuming application does not need to be aware of the streams, or supply any stream related information when attaching. It simply consumes the messages as they are delivered to it by the MOM.

Many consuming instances can attach to the MOM, and process messages for different streams in parallel

The remaining limitation of the logic in this disclosure is that a single queue must exist within the MOM.

This disclosure has value as application logic is usually a much larger part of the overall processing workload than the connectivity logic, and MOM technologies such as WebSphere® MQ can scale to a large workload for a single queue.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

As will be appreciated by one skilled in the art, aspects of the present invention may be embodied as a system, method, computer program product or computer program. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Java and all Java-based, trademarks and logos are trademarks or registered trademarks of Oracle and/or its affiliates.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should, also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

For the avoidance of doubt, the term “comprising”, as used herein throughout the description and claims is not to be construed as meaning “consisting only of”. Improvements and modifications can be made to the foregoing without departing from the scope of the present invention.

1. A method for consuming ordered streams of messages in a message oriented middleware having a single queue, comprising;
providing a first consuming application thread to process a first message;
locking a first message available on a queue to the first consuming application thread and locking all subsequent messages on the queue with a same stream identifier as the first message to the first consuming application thread;
identifying further messages with different stream identifiers currently locked to the first application thread, and making available the further messages to other consuming application threads; and
delivering the first message to the first consuming application thread.

2. The method of claim 1, further comprising:
providing a second consuming application thread to process a subsequent message; and
locking a next unlocked message available on the queue to the second consuming application thread and locking ail subsequent messages on the queue with a same stream identifier as the next unlocked message to the second consuming application thread;
wherein parallel processing of messages is carried out by the first and second consuming application threads.

3. The method of claim 1, further comprising:
checking if a next message available on the queue for the first consuming application thread is locked with the same stream identifier as the first message; and,
if so, delivering the next message to the first consuming application thread.

4. The method of claim 3, further comprising:
waiting a period of time for messages with the same stream identifier as the first message before the first consuming application thread receives message with a different stream identifier.

5. The method of claim 1, further comprising:
providing a stream identifier in a message being placed in the queue.

6. The method of claim 1, wherein a given consuming application thread remembers a last stream from which the given consuming application thread processed a message.

7. The method of claim 1, further comprising releasing the first consuming application thread's ownership of a stream corresponding to the stream identifier responsive to the first consuming application thread processing another message having a different stream identifier.

8. The method of claim 1, wherein a given consuming application thread finishes processing each message before it requests a next message.

9. A system for consuming ordered streams of messages in a message oriented middleware having a single queue, comprising:
an application thread availability component providing a first consuming application thread to process a first message;
a message availability component determining the first message is available on the queue;
a locking component for locking the first message available on the queue to the first consuming application thread and locking all subsequent messages on the queue with a same stream identifier as the first message to the first consuming application thread;
a lock check component for identifying further messages with different stream identifiers currently locked to the first consuming application thread;
a lock release component for making available the further messages to other consuming application threads; and
a message delivery component for delivering the first message to the first consuming application thread.

10. The system of claim 9, further comprising:
the application thread availability component providing a second consuming application thread to process a subsequent message; and
the locking component locking a next unlocked message available on the queue to the second consuming application thread and locking all subsequent messages on queue with a same stream identifier as the next unlocked message to the second consuming application thread;
wherein parallel processing of messages is carried out by the first and second consuming application threads.

11. The system of claim 9 further comprising:
the message availability component checking if a next message available on the queue for the first consuming application thread is locked with the same stream identifier as the first message.

12. The system as of claim 11, further comprising:
the message availability component waiting a period of time for messages with the same stream identifier as the first message before the first consuming application thread receives message with a different stream identifier.

13. The system of claim 9, further comprising:
a stream identifier provided is a message being placed in the queue

14. The system of claim 9, wherein a given consuming application thread remembers a last stream from which the given consuming application thread processed a message.

15. The system of claim 9, wherein the lock release component the first consuming application thread's ownership of a stream corresponding to the stream identifier responsive to the first consuming application thread processing another message having a different stream identifier.

16. The system of claim 9, wherein a given consuming application thread finishes processing each message before it requests a next message.

17. A computer program product for consuming ordered streams of messages in a message oriented middleware having a single queue, the computer program product comprising: a computer readable storage medium readable by a processing circuit and storing instructions for execution by the processing circuit to:
provide a first consuming application thread to process a first message;
locking a first message available on a queue to the first consuming application thread and locking all subsequent messages on the queue with same stream identifiers as the message to the first consuming application thread;
identifying further messages with different stream identifiers currently locked to the first application thread, and making available the further messages to other consuming application threads; and
delivering the first message to the first consuming application thread.

18-20. (canceled)

21. The computer program product of claim 17, wherein the instructions further cause the processing circuit to:
provide a second consuming application thread to process a subsequent message; and
lock a next unlocked message available on the queue to the second consuming application thread and locking all subsequent messages on the queue with a same stream identifier as the next unlocked message to the second consuming application thread;
wherein parallel processing of messages is carried out by the first and second consuming application threads.

22. The computer program product of claim 17, wherein the instructions further cause the processing circuit to:
check if a next message available on the queue for the first consuming application thread is locked with the same stream identifier as the first message; and,
if so, deliver the next message to the first consuming application thread.

23. The computer program product of claim 22, wherein the instructions further cause the processing circuit to:
wait a period of time for messages with the same stream identifier as the first message before the first consuming application thread receives message with a different stream identifier.
